(19) United States
(12) Patent Application Publication
(10) Pub. No.: US 2011/0187499 A1
(43) Pub. Date: Aug. 4, 2011

(54) METHOD FOR OPERATING A MOTOR VEHICLE

(76) Inventor: Ulrich Mueller, Ingolstadt (DE)

(21) Appl. No.: 12/697,352

(22) Filed: Feb. 1, 2010

(51) Int. Cl. G06F 7/04; G01C 21/26; G06F 7/00

(52) U.S. Cl. 340/5.81; 701/200; 701/36

(57) ABSTRACT

In a method for operating a motor vehicle (1) an identification identifier (2) for a driver of the motor vehicle (1) is determined depending on the time lag between at least two events.

### TECHNICAL FIELD

The invention relates to a method for operating a motor vehicle by means of a driver identification. The invention furthermore relates to a motor vehicle comprising a driver identification.

### BACKGROUND

DE 10 2004 044 771 A1 discloses a method for image based driver identification in a motor vehicle by means of photographing at least one two-dimensional driver face image using a camera, intermediate storage of driver face images taken and comparing intermediately stored driver face images to two-dimensional reference images of each of a possible driver from a plurality of possible drivers of the motor vehicle, wherein the actual angle of exposure between the camera and the normal of the face of the driver is determined by a device otherwise not serving the image based driver identification, and wherein the method for the image based driver identification is forwarded and the exposure of a driver face image is initiated when the actual angle of exposure reaches a certain predetermined value.

DE 10 2004 062 641 A1 discloses a method and a device for driver identification in a vehicle, wherein the vehicle is formed comprising at least one RFID reader, to at least one authorized driver of the vehicle at least one RFID sender is assigned which is provided with an unique identifier, and the identifier is detected and evaluated by means of the RFID reader.

### SUMMARY

According to various embodiments, a driver identification and identifier, respectively, can be created more cost effective for functions not being security relevant. Furthermore, according to various embodiments, the driver identification can be improved. In addition, according to various embodiments disadvantages according to the prior art can be avoided.

According to an embodiment, a method for operating a motor vehicle may comprise the step of generating an identification identifier for a driver of the motor vehicle depending on the time lag between at least two events from the group consisting of: pressing an opening element of a key of the motor vehicle, touching a door handle of the motor vehicle, opening a door of the motor vehicle, stepping on a brake pedal of the motor vehicle, establishing an ignition contact of the motor vehicle, establishing an ignition S-contact of the motor vehicle, establishing an ignition 1-contact of the motor vehicle, establishing an ignition 2-contact of the motor vehicle, selecting a gear, selecting the gear R, selecting the gear N, selecting the gear D, and releasing a parking brake of the motor vehicle.

According to a further embodiment, at least one of the following steps can be performed: settings of an infotainment system are automatically set depending on the identification identifier, settings of a display are automatically set depending on the identification identifier, routes are determined by means of a navigation system depending on the identification identifier, and an automatic climate control is automatically set depending on the identification identifier. According to yet a further embodiment, the identification identifier in addition can be determined depending on at least one of the variables from the group consisting of: duration of the pressing of the opening element of the key of the motor vehicle, duration of the touching of the door handle of the motor vehicle, duration of the opened state of the door of the motor vehicle, pressure onto the brake pedal of the motor vehicle, duration of the ignition contact of the motor vehicle, duration des ignition S-contact of the motor vehicle, duration of the ignition 1-contact of the motor vehicle, duration of the ignition 2-contact of the motor vehicle, and duration of the releasing of the parking brake of the motor vehicle. According to yet a further embodiment, the method may further comprise at least one step from the group consisting of: automatic setting of settings of an infotainment system depending on the identification identifier, automatic setting of settings of a display depending on the identification identifier, determining of routes by means of a navigation system depending on the identification identifier, and automatic setting of an automatic climate control depending on the identification identifier. According to yet a further embodiment, the identification identifier in addition can be determined depending on at least one of the variables from the group consisting of: week day, time of day, position, seat memory setting, seat setting, key identification, direction of an approach towards the motor vehicle, speed of an approach towards the motor vehicle, movement of the steering wheel during getting into the motor vehicle, and sequence of the opening of doors prior to getting into the motor vehicle. According to yet a further embodiment, the identification identifier in addition can be determined depending on at least one of the variables from the group consisting of: week day, time of day, position, seat memory setting, seat setting, key identification, direction of an approach towards the motor vehicle, speed of an approach towards the motor vehicle, movement of the steering wheel during getting into the motor vehicle, and sequence of the opening of doors prior to getting into the motor vehicle.

According to another embodiment, a method for operating a motor vehicle may comprise the step of: generating an identification identifier for a driver of the motor vehicle depending on at least one of the variables from the group consisting of: duration of pressing an opening element of a key of the motor vehicle, duration of touching a door handle of the motor vehicle, duration of the opened state of a door of the motor vehicle, pressure onto a brake pedal of the motor vehicle, duration of an ignition contact of the motor vehicle, duration of an ignition S-contact of the motor vehicle, duration of an ignition 1-contact of the motor vehicle, duration of an ignition 2-contact of the motor vehicle, and duration of the releasing of a parking brake of the motor vehicle.

According to a further embodiment, such a method may further comprise at least one step from the group consisting of: automatic setting of settings of an infotainment system depending on the identification identifier, automatic setting of settings of a display depending on the identification identifier, determining of routes by means of a navigation system depending on the identification identifier, automatic setting of an automatic climate control depending on the identification identifier. According to yet a further embodiment, the identification identifier in addition may be determined depending on at least one of the variables from the group consisting of: week day, time of day, position, seat memory setting, seat setting, key identification, direction of an approach towards the motor vehicle, speed of an approach towards the motor vehicle, movement of the steering wheel during getting into the motor vehicle, and sequence of the opening of doors prior to getting into the motor vehicle. According to yet a further embodiment, the identification identifier in addition may be determined depending on at least one of the variables from the group consisting of: week day, time of day, position, seat memory setting, seat setting, key identification, direction of an approach towards the motor vehicle, speed of an approach towards the motor vehicle, movement of the steering wheel during getting into the motor vehicle, and sequence of the opening of doors prior to getting into the motor vehicle.

According to yet another embodiment, a motor vehicle may comprise: a driver identification module operable to identify a driver of the motor vehicle depending on the time lag between at least two of the events from the group consisting of: pressing an opening element of a key of the motor vehicle, touching a door handle of the motor vehicle, opening a door of the motor vehicle, stepping on a brake pedal of the motor vehicle, establishing an ignition contact of the motor vehicle, establishing an ignition S-contact of the motor vehicle, establishing an ignition 1-contact of the motor vehicle, establishing an ignition 2-contact of the motor vehicle, selecting a gear, selecting the gear R, selecting the gear N, selecting the gear D, and releasing a parking brake of the motor vehicle. According to yet a further embodiment, the motor vehicle may further comprise an infotainment system, wherein settings of the infotainment system are adjustable automatically depending on an output signal of the driver identification module. According to yet a further embodiment, the motor vehicle may further comprise a display, wherein settings of the display are adjustable automatically depending on an output signal of the driver identification module. According to yet a further embodiment, the motor vehicle may further comprise a navigation system, wherein routes are ascertainable by means of the navigation system depending on an output signal of the driver identification module. According to yet a further embodiment, the motor vehicle may further comprise an automatic climate control, wherein the automatic climate control is adjustable automatically depending on an output signal of the driver identification module. According to yet a further embodiment, by means of the driver identification module the identification of a driver of the motor vehicle in addition can be performed with at least one of the variables from the group consisting of: duration of pressing the opening element of the key of the motor vehicle, duration of touching the door handle of the motor vehicle, duration of the opened state of the door of the motor vehicle, pressure onto the brake pedal of the motor vehicle, duration of the ignition contact of the motor vehicle, duration of the ignition S-contact of the motor vehicle, duration of the ignition 1-contact of the motor vehicle, duration of the ignition 2-contact of the motor vehicle, and duration of the releasing of the parking brake of the motor vehicle.

According to yet another embodiment, a motor vehicle may comprise a driver identification module for identifying a driver of the motor vehicle depending on at least one of the variables from the group consisting of: duration of pressing an opening element of a key of the motor vehicle, duration of touching a door handle of the motor vehicle, duration of the opened state of a door of the motor vehicle, pressure onto a brake pedal of the motor vehicle, duration of an ignition contact of the motor vehicle, duration of an ignition S-contact of the motor vehicle, duration of an ignition 1-contact of the motor vehicle, duration of an ignition 2-contact of the motor vehicle, and duration of the releasing of a parking brake.

According to yet a further embodiment, such a motor vehicle may further comprise an infotainment system, wherein settings of the infotainment system are adjustable automatically depending on an output signal of the driver identification module. According to yet a further embodiment, such a motor vehicle may further comprise a display, wherein settings of the display are adjustable automatically depending on an output signal of the driver identification module. According to yet a further embodiment, such a motor vehicle may further comprise a navigation system, wherein routes may be determined by means of the navigation system depending on an output signal of the driver identification module. According to yet a further embodiment, such a motor vehicle may further comprise an automatic climate control, wherein the automatic climate control is adjustable automatically depending on an output signal of the driver identification module.

### BRIEF DESCRIPTION OF THE DRAWINGS

FIG. 1 shows an exemplary embodiment of a motor vehicle in a functional schematic diagram;

FIG. 2 shows an exemplary embodiment of a vehicle control;

FIG. 3 shows an exemplary embodiment of a driver identification module;

FIG. 4 shows an exemplary embodiment of a “fingerprint” as it may be result from the input variables of a driver identification module according to FIG. 3 for example;

FIG. 5 shows the “fingerprint” according to FIG. 4 supplemented by the designation of the variables used.

### DETAILED DESCRIPTION

According to various embodiments, in a method for operating a motor vehicle, an identification identifier for a driver of the motor vehicle is determined depending on the time lag between at least two of the events from the group consisting of pressing an opening element of a key of the motor vehicle, touching a door handle of the motor vehicle, opening a door of the motor vehicle, stepping on a brake pedal of the motor vehicle, establishing an ignition contact of the motor vehicle, establishing an of the motor vehicle, establishing an ignition 1-contact of the motor vehicle, establishing an ignition 2-contact of the motor vehicle, selecting a gear, selecting the gear R, selecting the gear N, selecting the gear D and releasing a parking brake and/or depending on at least the duration of the pressing of the opening element of the key of the motor vehicle, the duration of the touching of the door handle of the motor vehicle, the duration of the opened state of the door of the motor vehicle, of the pressure onto the brake pedal of the motor vehicle, the duration of the ignition contact of the motor vehicle, the duration of the ignition S-contact of the motor vehicle, the duration of the ignition 1-contact of the motor vehicle, the duration of the ignition 2-contact of the motor vehicle and/or the duration of the releasing of the parking brake of the motor vehicle.

An identification identifier in the sense of the invention in particular can be an ID assigned to a driver of the motor vehicle. An identification identifier in the sense of the invention in particular does not serve for use in security relevant applications in a motor vehicle. An identification identifier in the sense of the invention in particular serves mere convenience oriented applications. An identification identifier in the sense of the invention in particular does not serve the adjustment of a seat. An identification identifier in the sense of the invention in particular does not serve the adjustment of driving functions. An identification identifier in the sense of the invention in particular does not serve the access to the motor vehicle. An opening element of a key of a motor vehicle in the sense of the invention in particular can be a pushbutton of a key for wireless opening of a motor vehicle.

In an embodiment, settings 13 of an infotainment system are set automatically depending on the identification identifier and/or pre-settings 14 of a display are set automatically depending on the identification identifier. For example, settings of an infotainment system may be selecting a radio station or a CD in a CD changer. For example, settings of a display may apply to the adjustment of the color scheme of the display and/or the size of alphanumeric characters or icons.

In a further embodiment, by means of a navigation system, routes are determined depending on the identification identifier. In a further embodiment, an automatic climate control is automatically adjusted depending on the identification identifier. Thereby, for example settings in a navigation system are set depending on the identification identifier, as for example if the shortest or the fastest route shall be selected, or if freeways shall be avoided. It is in particular provided for that typical settings of a navigation system are set depending on an identification identifier so that the routes are determined depending on the identification identifier.

In a further embodiment, the identification identifier in addition is detected depending on the week day, the time of day, the position of the motor vehicle, the seat memory setting, the seat setting, the key identification, the direction of an approach towards the motor vehicle, the speed of an approach towards the motor vehicle, the movement of the steering wheel when getting into the motor vehicle and/or the sequence of the opening of doors of the motor vehicle prior to getting into the motor vehicle. A position of a motor vehicle in the sense of the invention in particular is a geographic position, as it may be provided by a navigation system for example. A position of a motor vehicle in the sense of the invention alternatively and in addition may in particular also be the position of the motor vehicle related to a stationary facility, such as a building for example. Thus, the position of a motor vehicle may for example indicate if the motor vehicle is located inside or outside of a garage.

Aforementioned goal is reached by means of a motor vehicle, wherein the motor vehicle comprises a driver identification module for identifying a driver of the motor vehicle depending on the time lag between at least two of the events from the group consisting of pressing an opening element of a key of the motor vehicle, touching a door handle of the motor vehicle, opening a door of the motor vehicle, stepping on a brake pedal of the motor vehicle, establishing an ignition contact of the motor vehicle, establishing an ignition S-contact of the motor vehicle, establishing an ignition 1-contact of the motor vehicle, establishing an ignition 2-contact of the motor vehicle, selecting a gear, selecting the gear R, selecting the gear N, selecting the gear D and releasing a parking brake and/or depending on at least the duration of the pressing of the opening element of the key of the motor vehicle, the duration of the touching of the door handle of the motor vehicle, the duration of the opened state of the door of the motor vehicle, the pressure onto the brake pedal of the motor vehicle, the duration of the ignition contact of the motor vehicle, the duration of the ignition S-contact of the motor vehicle, the duration of the ignition 1-contact of the motor vehicle, the duration of the ignition 2-contact of the motor vehicle and/or the duration of the releasing of the parking brake of the motor vehicle.

In an embodiment, the motor vehicle comprises an infotainment system, wherein settings of the infotainment system are adjustable automatically depending on an output signal of the driver identification module. In a further embodiment, the motor vehicle comprises a display, wherein settings of the display are adjustable automatically depending on the output signal of the driver identification module. In a further embodiment, the motor vehicle comprises a navigation system, wherein routes are ascertainable by means of the navigation system depending on the output signal of the driver identification module. In a further embodiment, the motor vehicle comprises an automatic climate control, wherein the automatic climate control is adjustable automatically depending on the output signal of the driver identification module.

In a further embodiment, the identification of the driver of the motor vehicle in addition is provided depending on the week day, the time of day, the position of the motor vehicle, the seat memory setting, the seat setting, the key identification, the direction of an approach towards the motor vehicle, the speed of an approach towards the motor vehicle, the movement of the steering wheel when getting into the motor vehicle and/or the sequence of the opening of doors of the motor vehicle prior to getting into the motor vehicle.

A motor vehicle in the sense of the invention in particular is a land craft for individual use in road traffic. Motor vehicles in the sense of the invention in particular are not limited to land crafts comprising internal combustion engines.

Further advantages and details arise from the following description of exemplary embodiments.

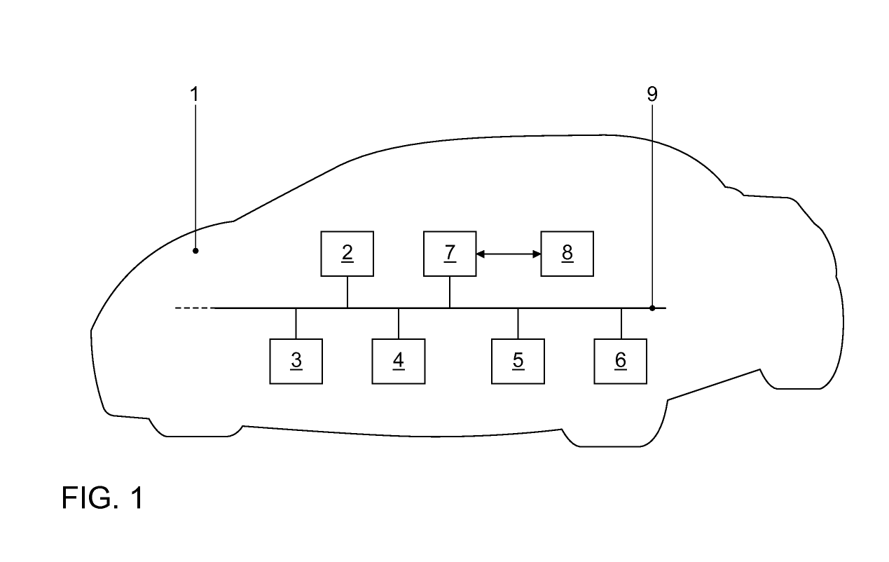

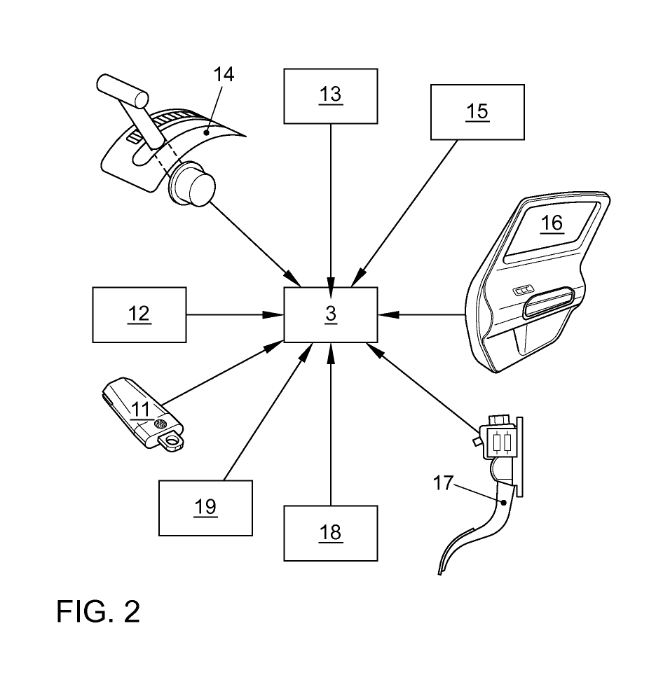

FIG. 1 shows an exemplary embodiment of a motor vehicle in a functional schematic diagram. Thereby, motor vehicle 1 comprises a navigation system 4, an automatic climate control 5 and an infotainment system 6 as well as a display and operating device 8 for operating the navigation system 4 of the automatic climate control and the infotainment system 6. For that purpose a display and operating control 7 is provided which is communicatively connected to the navigation system 4, the automatic climate control 5 as well as the infotainment system 6 via a bus system 9. Die display and operating device 8 is an exemplary embodiment of a display in the sense of the invention.

In addition, a vehicle control 3 and a driver identification module 2 are communicatively coupled to the bus system 9. Processed in the vehicle control 3 are in particular information of a key 11 for opening the motor vehicle 1, the ignition lock 12 of the motor vehicle 1, the gear shift 14 of the motor vehicle 1, the parking brake 15 of the motor vehicle 1, the doors 16 of the motor vehicle 1, the brake 17 of the motor vehicle 1, the driver's seat 18 of the motor vehicle 1 and a park distance control 19 of the motor vehicle 1.

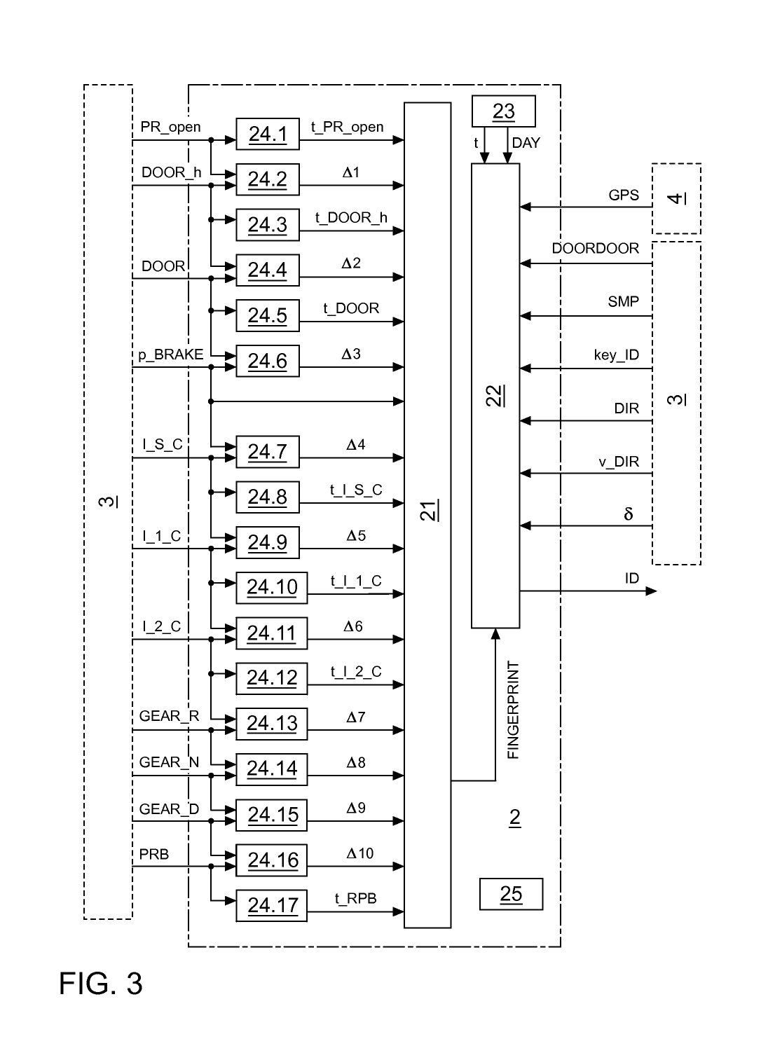

The settings of the navigation system 4, the automatic climate control 5, the infotainment system 6 and the display 8 are adjustable driver dependent and depending on an identification identifier which is provided and transmitted, respectively, by the driver identification module 2. For that purpose, as depicted in FIG. 3, the duration t_PR_open of the pressing PR_open of the opening element of the key of the motor vehicle 1, the duration t_DOOR_h of the touching DOOR_h of the door handle of the motor vehicle 1, the duration t_DOOR of the opened state DOOR of the door of the motor vehicle 1, of the pressure p_BRAKE onto the brake pedal of the motor vehicle 1, the duration of the ignition contact of the motor vehicle 1, the duration t_I_S_C of the ignition S-contact I_S_C of the motor vehicle 1, the duration t_I_1_C of the ignition 1-contact I_1_C of the motor vehicle 1, the duration t_I_2_C of the ignition 2-contact I_2_C of the motor vehicle 1 and the duration t_RPB of the releasing RPB of the parking brake of the motor vehicle 1 are transmitted from the vehicle control 6 to the driver identification module 2.

The driver identification module 2 comprises time measuring devices 24.1, 24.2, 24.3, 24.4, 24.5, 24.6, 24.7, 24.8, 24.9, 24.10, 24.11, 24.12, 24.13, 24.14, 24.15, 24.16 and 24.17. Thereby, reference numeral 24.1 indicates a time measuring device for determining the duration t_PR_open of the pressing PR_open of the opening element of the key of the motor vehicle 1, reference numeral 24.3 indicates a time measuring device for determining the duration t_DOOR of the touching of DOOR_h of the door handle of the motor vehicle 1, reference numeral 24.5 indicates ‘a time measuring device for determining the duration t_DOOR of the opened state DOOR of the door of the motor vehicle 1, reference numeral 24.8 indicates a time measuring device for determining the duration t_I_S_C of the ignition S-contact I_S_C of the motor vehicle’ 1, reference numeral 24.10 indicates a time measuring device for determining the duration ‘t_I_1_C of the ignition 1-contact I_1_C of the motor vehicle 1, reference numeral 24.12 indicates a time measuring device for determining the duration t_I_2_C of the ignition 2-contact I_2_C of the motor vehicle 1, reference numeral 24.17 indicates a time measuring device for determining the duration t_RPB of the releasing RPB of the parking brake of the motor vehicle 1.

Reference numeral 24.2 indicates a time measuring device for determining the time lag Δ1 between the pressing PR_open of the opening element of the key of the motor vehicle. 1 and the touching DOOR_h of the door handle of the motor vehicle 1. Reference numeral 24.4 indicates a time measuring device for determining the time lag Δ2 between the touching DOOR_h of the door handle of the motor vehicle 1 and the opening DOOR of the door of the motor vehicle 1. Reference numeral 24.6 indicates a time measuring device for determining the time lag Δ3 between the opening DOOR of the door of the motor vehicle 1 and the stepping onto the brake pedal of the motor vehicle 1. Reference numeral 24.7 indicates a time measuring device for determining the time lag Δ4 between the stepping onto the brake pedal of the motor vehicle 1 and the establishing of the ignition S-contact I_S_C of the motor vehicle 1. Reference numeral 24.9 indicates a time measuring device for determining the time lag Δ5 between the establishing I_S_C of the ignition S-contact of the motor vehicle 1 and the establishing l_1_C of the ignition 1-contact of the motor vehicle 1. Reference numeral 24.11 indicates a time measuring device for determining the time lag Δ6 between the establishing I_1_C of the ignition 1-contact of the motor vehicle 1 and the establishing I_2_C of the ignition 2-contact of the motor vehicle 1. Reference numeral 24.13 indicates a time measuring device for determining the time lag Δ7 between the establishing I_2_C of the ignition 2-contact of the motor vehicle 1 and the selecting GEAR_R of the gear R. Reference numeral 24.14 indicates a time measuring device for determining the time lag Δ8 between the selecting GEAR_R of the gear R and the selecting GEAR_N of the gear N. Reference numeral 24.15 indicates a time measuring device for determining the time lag Δ9 between the selecting GEAR_N of the gear N and the selecting GEAR_D of the gear D. Reference numeral 24.16 indicates a time measuring device for determining the time lag Δ10 between the selecting GEAR_D of the gear D and the releasing RPB of the parking brake of the motor vehicle 1.

The driver identification module 2 comprises a module 21 for determining an internal identification identifier FINGERPRINT depending on the duration t_PR_open of the pressing PR_open of the opening element of the key of the motor vehicle 1, the duration t_DOOR_h of the touching DOOR_h of the door handle of the motor vehicle 1, the duration t_DOOR of the opened state DOOR of the door of the motor vehicle 1, of the pressure p_BRAKE onto the brake pedal of the motor vehicle 1, the duration of the ignition contact of the motor vehicle 1, the duration t_I_S_C of the ignition S-contact l_S_C of the motor vehicle 1, the duration t_I_1_C of the ignition 1-contact I_1_C of the motor vehicle 1, the duration t_I_2_C of the ignition 2-contact I_2_C of the motor vehicle 1, the duration t_RPB of the releasing RPB of the parking brake of the motor vehicle 1, the time lag Δ1 between the pressing PR_open of the opening element of the key of the motor vehicle 1 and the touching DOOR_h of the door handle of the motor vehicle 1, the time lag Δ2 between the touching DOOR_h of the door handle of the motor vehicle 1 and the opening DOOR of the door of the motor vehicle, the time lag Δ3 between the opening DOOR of the door of the motor vehicle 1 and the stepping onto the brake pedal of the motor vehicle 1, the time lag Δ4 between the stepping onto the brake pedal of the motor vehicle 1 and the establishing of the ignition S-contact l_S_C of the motor vehicle 1, the time lag Δ5 between the establishing l_S_C of the ignition S-contact of the motor vehicle 1 and the establishing I_1_C of the ignition 1-contact of the motor vehicle 1, the time lag Δ6 between the establishing l_1_C des ignition 1-contact of the motor vehicle 1 and the establishing l_2_C of the ignition 2-contact of the motor vehicle 1, the time lag Δ7 between the establishing I_2_C of the ignition 2-contact of the motor vehicle 1 and the selecting GEAR_R of the gear R and the time lag Δ8 between the selecting GEAR_R of the gear R and the selecting GEAR_N of the gear N, the time lag Δ9 between the selecting GEAR_N of the gear N and the selecting GEAR_D of the gear D, the time lag Δ10 between the selecting GEA,R_D of the gear D and the releasing RPB of the parking brake of the motor vehicle 1. The internal identification identifier FINGERPRINT is an exemplary embodiment of an identification identifier in the sense of the claims. In an exemplary embodiment it may be provided for that the internal identification identifier FINGERPRINT is output as an identification identifier ID (i.e. as an output signal of the driver identification module 2). The identification identifier ID also is an exemplary embodiment of an identification identifier in the sense of the claims.

It may also be provided for that an additional module 22 is provided by means of which the identification identifier ID is determined depending on the internal identification identifier FINGERPRINT, the time of day t, the week day DAY, the identifier key_ID (exemplary embodiment of a key identification in the sense of the claims) of a key 11 which was used to open the motor vehicle 1, a seat memory setting SMP and seat setting of the driver's seat 18, the direction DIR of an approach towards the motor vehicle 1 (based on the sensor system of the park distance control), the speed v_DIR of an approach towards the motor vehicle (based on the sensor system of the park distance control), the movement δ of the steering wheel 13 during getting into the motor vehicle 1 and the sequence of the opening of doors 16 prior to getting into the motor vehicle 1.

It may also be provided for that the time of day t and the week day D are provided by the vehicle control 3 or by an internal clock 23.

Furthermore, an internal operating element 25 may be provided for which may be set in a body shop or during servicing, for example, so that the driver identification module 2 is taken out of operation. This then is of advantage when the motor vehicle 1 is not used as an individual vehicle but is provided as a pool vehicle.

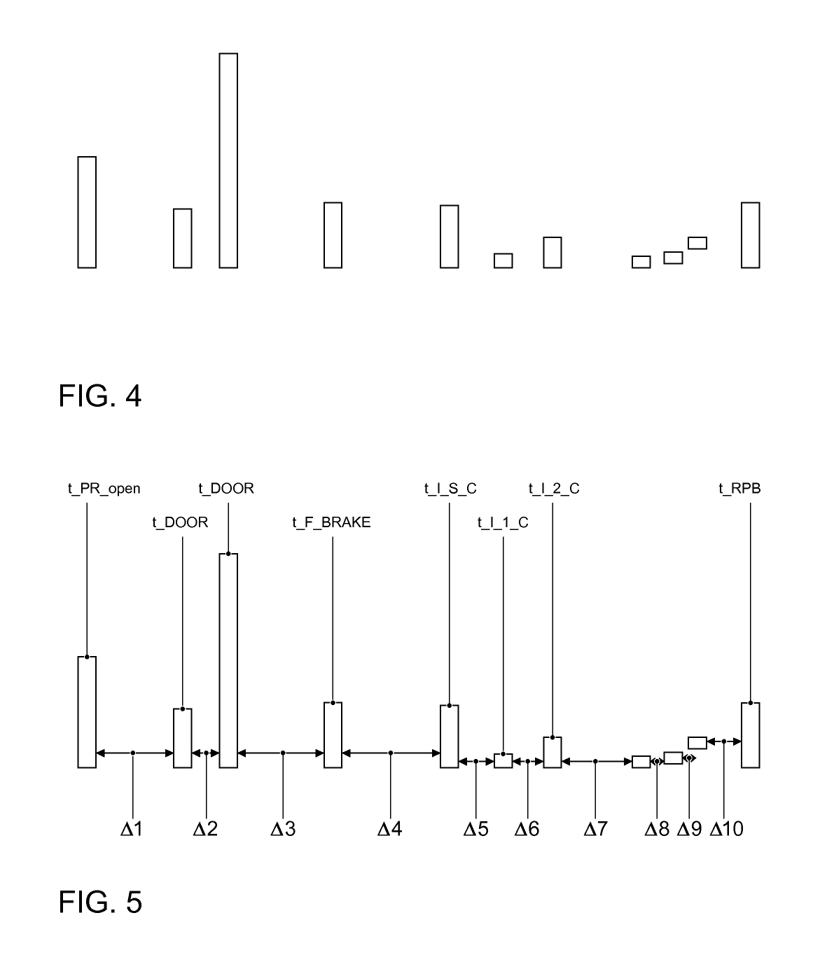

For example, for implementing the module 21 a pattern recognition may provided or an identification software as for example used for identifying a user of a keyboard. FIG. 4 shows a typical pattern as resulting from the input values of the module 21, wherein FIG. 4 is supplemented by these values in FIG. 5. The so called “fingerprint” according to FIG. 4 may for example be evaluated by means of a pattern recognition for generating the internal identification identifier FINGERPRINT.

What is claimed is:

1. A method for operating a motor vehicle, the method comprising the step of:
generating an identification identifier for a driver of the motor vehicle depending on the time lag between at least two events from the group consisting of:
pressing an opening element of a key of the motor vehicle,
touching a door handle of the motor vehicle,
opening a door of the motor vehicle,
stepping on a brake pedal of the motor vehicle,
establishing an ignition contact of the motor vehicle,
establishing an ignition S-contact of the motor vehicle,
establishing an ignition 1-contact of the motor vehicle,
establishing an ignition 2-contact of the motor vehicle,
selecting a gear,
selecting the gear R,
selecting the gear N,
selecting the gear D, and
releasing a parking brake of the motor vehicle.

2. The method according to claim 1, performing at least one of:
settings of an infotainment system are automatically set depending on the identification identifier,
settings of a display are automatically set depending on the identification identifier,
routes are determined by means of a navigation system depending on the identification identifier, and
an automatic climate control is automatically set depending on the identification identifier.

3. The method according to claim 1, wherein the identification identifier in addition is determined depending on at least one of the variables from the group consisting of:
duration of the pressing of the opening element of the key of the motor vehicle,
duration of the touching of the door handle of the motor vehicle,
duration of the opened state of the door of the motor vehicle,
pressure onto the brake pedal of the motor vehicle,
duration of the ignition contact of the motor vehicle,
duration des ignition S-contact of the motor vehicle,
duration of the ignition 1-contact of the motor vehicle,
duration of the ignition 2-contact of the motor vehicle, and
duration of the releasing of the parking brake of the motor vehicle.

4. The method according to claim 3, further comprising at least one step from the group consisting of:
automatic setting of settings of an infotainment system depending on the identification identifier,
automatic setting of settings of a display depending on the identification identifier,
determining of routes by means of a navigation system depending on the identification identifier, and
automatic setting of an automatic climate control depending on the identification identifier.

5. The method according to claim 4, wherein the identification identifier in addition is determined depending on at least one of the variables from the group consisting of:
week day,
time of day,
position,
seat memory setting,
seat setting,
key identification,
direction of an approach towards the motor vehicle,
speed of an approach towards the motor vehicle,
movement of the steering wheel during getting into the motor vehicle, and
sequence of the opening of doors prior to getting into the motor vehicle.

6. The method according to claim 3, wherein the identification identifier in addition is determined depending on at least one of the variables from the group consisting of:
week day,
time of day,
position,
seat memory setting,
seat setting,
key identification,
direction of an approach towards the motor vehicle,
speed of an approach towards the motor vehicle,
movement of the steering wheel during getting into the motor vehicle, and
sequence of the opening of doors prior to getting into the motor vehicle.

7. A method for operating a motor vehicle comprising the step of:
generating an identification identifier for a driver of the motor vehicle depending on at least one of the variables from the group consisting of:
duration of pressing an opening element of a key of the motor vehicle,
duration of touching a door handle of the motor vehicle,
duration of the opened state of a door of the motor vehicle,
pressure onto a brake pedal of the motor vehicle,
duration of an ignition contact of the motor vehicle,
duration of an ignition S-contact of the motor vehicle,
duration of an ignition 1-contact of the motor vehicle,
duration of an ignition 2-contact of the motor vehicle, and
duration of the releasing of a parking brake of the motor vehicle.

8. The method according to claim 7, further comprising at least one step from the group consisting of:
automatic setting of settings of an infotainment system depending on the identification identifier,
automatic setting of settings of a display depending on the identification identifier,
determining of routes by means of a navigation system depending on the identification identifier,
automatic setting of an automatic climate control depending on the identification identifier.

9. The method according to claim 8, wherein the identification identifier in addition is determined depending on at least one of the variables from the group consisting of:
week day,
time of day,
position,
seat memory setting,
seat setting,
key identification,
direction of an approach towards the motor vehicle,
speed of an approach towards the motor vehicle,
movement of the steering wheel during getting into the motor vehicle, and
sequence of the opening of doors prior to getting into the motor vehicle.

10. The method according to claim 7, wherein the identification identifier in addition is determined depending on at least one of the variables from the group consisting of:
week day,
time of day,
position,
seat memory setting,
seat setting,
key identification,
direction of an approach towards the motor vehicle,
speed of an approach towards the motor vehicle,
movement of the steering wheel during getting into the motor vehicle, and
sequence of the opening of doors prior to getting into the motor vehicle.

11. A motor vehicle comprising:
a driver identification module operable to identify a driver of the motor vehicle depending on the time lag between at least two of the events from the group consisting of:
pressing an opening element of a key of the motor vehicle,
touching a door handle of the motor vehicle,
opening a door of the motor vehicle,
stepping on a brake pedal of the motor vehicle,
establishing an ignition contact of the motor vehicle,
establishing an ignition S-contact of the motor vehicle,
establishing an ignition 1-contact of the motor vehicle,
establishing an ignition 2-contact of the motor
vehicle,
selecting a gear,
selecting the gear R,
selecting the gear N,
selecting the gear D, and
releasing a parking brake of the motor vehicle.

12. The motor vehicle according to claim 11, further comprising:
an infotainment system, wherein settings of the infotainment system are adjustable automatically depending on an output signal of the driver identification module.

13. The motor vehicle according to claim 11, further comprising:
a display, wherein settings of the display are adjustable automatically depending on an output signal of the driver identification module.

14. The motor vehicle according to claim 11, further comprising:
a navigation system, wherein routes are ascertainable by means of the navigation system depending on an output signal of the driver identification module.

15. The motor vehicle according to claim 11, further comprising:
an automatic climate control, wherein the automatic climate control is adjustable automatically depending on an output signal of the driver identification module.

16. The motor vehicle according to claim 11, wherein by means of the driver identification module the identification of a driver of the motor vehicle in addition is performed with at least one of the variables from the group consisting of:
duration of pressing the opening element of the key of the motor vehicle,
duration of touching the door handle of the motor vehicle,
duration of the opened state of the door of the motor vehicle,
pressure onto the brake pedal of the motor vehicle,
duration of the ignition contact of the motor vehicle,
duration of the ignition S-contact of the motor vehicle,
duration of the ignition 1-contact of the motor vehicle,
duration of the ignition 2-contact of the motor vehicle, and
duration of the releasing of the parking brake of the motor vehicle.

17. A motor vehicle comprising:
a driver identification module for identifying a driver of the motor vehicle depending on at least one of the variables from the group consisting of:
duration of pressing an opening element of a key of the motor vehicle,
duration of touching a door handle of the motor vehicle,
duration of the opened state of a door of the motor vehicle,
pressure onto a brake pedal of the motor vehicle,
duration of an ignition contact of the motor vehicle,
duration of an ignition S-contact of the motor vehicle,
duration of an ignition 1-contact of the motor vehicle,
duration of an ignition 2-contact of the motor vehicle, and
duration of the releasing of a parking brake.

18. The motor vehicle according to claim 17, further comprising:
an infotainment system, wherein settings of the infotainment system are adjustable automatically depending on an output signal of the driver identification module.

19. The motor vehicle according to claim 17, further comprising:
a display, wherein settings of the display are adjustable automatically depending on an output signal of the driver identification module.

20. The motor vehicle according to claim 17, further comprising:
a navigation system, wherein routes may be determined by means of the navigation system depending on an output signal of the driver identification module.

21. The motor vehicle according to claim 17, further comprising:
an automatic climate control, wherein the automatic climate control is adjustable automatically depending on an output signal of the driver identification module.
